(19) United States
(12) Patent Application Publication
(10) Pub. No.: US 2002/0055594 A1
(43) Pub. Date: May 9, 2002

(54) Superabsorbent tablet and its uses

(76) Inventor: Florence Roux, Biarritz (FR)

Correspondence Address: Thomas W. Tolpin, Welsh & Katz, Ltd., 22nd Floor, 120 S. Riverside Plaza, Chicago, IL, 60606, US

(21) Appl. No.: 09/978,902

(22) Filed: Oct. 16, 2001

(30) Foreign Application Priority Data
Oct. 18, 2000 (FR) 0013314

(51) Int. Cl. C08F 120/02

(52) U.S. Cl. 525/329.7

(57) ABSTRACT

The present invention relates to a superabsorbent tablet capable of thickening bodily excretions (feces, urine, etc.) and to its uses. This tablet is characterized in that it comprises a pulverulent superabsorbent polymer having a density less than or equal to 5×10² kg/M³ and a gelling time of less than 6 seconds. The tablets can be used in bags for collecting bodily excretions such as ostomy or drainage bags, diapers for babies, articles of feminine hygiene.

### BACKGROUND OF THE INVENTION

The present invention relates to a superabsorbent tablet capable of thickening bodily excretions (feces, urine, etc.) and to its uses, especially in bags for collecting bodily excretions such as ostomy or drainage bags.

It has been proposed to introduce, into the bags worn by ostomy patients, for whom matter excreted by the stomach orifice is liquid and has a large volume—which is especially the case for patients who have undergone an ileostomy in order to collect this matter, a superabsorbent which swells in contact with the latter and allows it to be gelled, which especially has the effect of decreasing the risks of leakage of the excreted matter.

Since these patients most commonly use bags which can be emptied, it is necessary to introduce a new amount of superabsorbent after each emptying, and to do so via the emptying outlet with which these bags are fitted. However, apart from the fact that this emptying outlet consists of two walls made of plastic secured by their lateral edges, which are of small width (generally about 55 to 65 mm) and which tend to come together spontaneously—which often makes them relatively difficult to open—it is likely to be soiled by the excreted matter. Since a superabsorbent is, by nature, very sensitive to moisture, when it is in powder form, as soon as it comes into contact with the inner walls of the emptying outlet it tends to form a paste which adheres to these walls and which prevents it from progressing toward the central part of the bag.

It is therefore important that the superabsorbent is in a form which allows it, not only to be introduced easily into the emptying outlet, but also to slide without difficulty inside this emptying outlet such that it can reach the central part of the bag. However it is also essential that this form of presentation releases the superabsorbent as soon as it comes into contact with a liquid, which is not the case for forms in which the superabsorbent is retained inside an envelope, such as for example a gelatine envelope.

Hence, superabsorbent tablets have been proposed in European Patent Application 0 138 427 and in International Application PCT WO 97/38740.

These tablets have in common that they are obtained by compression of a mixture formed of a superabsorbent in the form of particles, and of one or more excipients.

Thus, the tablets described in EP-A-0 138 427 comprise from 25 to 75% by weight of a filler, preferably a hydrophilic filler such as silica or alumina fume, an aluminum silicate, vermiculite or else an elastic fiber. This filler has the function of preventing the particles of superabsorbent located on the surface of the tablets forming, by swelling in contact with the liquid having to be absorbed, a gelatinous gangue which then limits the penetration of this liquid inside the tablets and, subsequently, blocks the absorption capacity of the superabsorbent. This phenomenon is known by the term “gel blocking”.

As for the tablets described in WO-A-97/38740, these comprise 20 to 40% by weight of microcrystalline cellulose, preferably combined with 0.1 to 10% by weight of a hydrophilic lubricating agent. The microcrystalline cellulose, which in particular has the characteristic of being highly compressible, is intended to compensate for the low compressibility of the superabsorbent so that it lends itself to the compression operations. Moreover, since it is very hydrophilic, it facilitates the disintegration of tablets on contact with the liquid having to be absorbed and, consequently, the release of superabsorbent particles into this liquid. Thus, by means of this disintegrating action, the microcrystalline cellulose itself contributes to preventing the occurrence of gel blocking. As for the lubricating agent, it serves to facilitate the compression operations by stopping the particles of superabsorbent and of microcrystalline cellulose from adhering to the punches of the press and by helping the ejection of tablets from the dies by reducing friction forces.

The use of excipients, in the weight fractions envisaged in the aforementioned documents, has the major drawback of appreciably increasing the volume of matter subject to the compression operations. However, the choice of tablet size is necessarily limited by the diameter of the emptying outlet. Also, the higher the excipient content of the tablet, the higher the risk that the amount of superabsorbent introduced into the bags will be insufficient, given the volume of liquid matter likely to be collected in these bags, to gel the latter.

What this means is that the use of excipients, although supposed to make the superabsorbent tablets more effective, in fact curbs the proper efficiency of these tablets.

### BRIEF SUMMARY OF THE INVENTION

Within the scope of their work, the inventors have noticed with surprise, however, that by using a suitably selected superabsorbent, not only is it possible to compress this superabsorbent in the absence of any excipient and, therefore, to obtain tablets consisting solely of superabsorbent, but also, the tablets thus obtained, although free of excipient, are not subject to the phenomenon of gel blocking.

The subject of the present invention is therefore a tablet, characterized in that it comprises a pulverulent superabsorbent polymer having a density less than or equal to 5×10² kg/m³ and a gelling time of less than 6 seconds.

A more detailed explanation of the invention is provided in the following description and appended claims.

### DETAILED DESCRIPTION OF THE INVENTION

A superabsorbent tablet and its composition and uses according to the preferred embodiments of the invention will now be explained.

On the basis of their observations, the inventors actually demonstrated that the density of a superabsorbent is a parameter determining its ability to be compressed, while its gel time conditions its ability to have, when it is in compressed form, an absorption capacity very close to that which it has before compression, and that it is appropriate to use a superabsorbent having both a density at the most equal to 5×10² kg/m³ and a gelling time of less than 6 seconds if it is desired to obtain superabsorbent tablets which are capable of completely fulfilling their role without resorting to any excipient.

In the foregoing and in the following, the density values given are those obtained on determining the density of a superabsorbent according to standard NFT 51-003, while the gelling time values correspond to the values obtained after dispersion of 3 g of superabsorbent in 100 ml of an aqueous solution comprising 9 g/l sodium chloride and having a temperature of 20±1° C.

According to a first advantageous embodiment of the invention, the superabsorbent polymer is a crosslinked sodium or calcium polyacrylate. Among this type of polymer, it is especially preferable to use the sodium polyacrylate marketed by Elf Atochem under the brand name Norsocryl®, reference 99EX007, which has the dual advantage of having a density of about 4.2×10² kg/m³ and a gelling time of about 4 seconds

According to another advantageous embodiment of the invention, the tablet is free from excipient, which makes it possible not only to reduce as far as possible its volume and therefore its size according to the absorption capacity desired, but to manufacture it without having to carry out any mixing operation prior to the compression operations.

However, according to the invention, the tablet may also comprise one or more excipients, provided that they are present in a limited amount, that is to say, in practice that they do not represent more than 20% and, ideally, more than 15% by weight of the weight of the tablet.

Thus the tablet may especially comprise:

(a) a lubricating agent if it is considered necessary or desirable to facilitate the compression operations, either by non-adherent action, or by anti-friction action, or else by an action regulating the flow of superabsorbent particles in the dies of the press;

(b) a highly compressible diluting agent when it is desired to increase its cohesion and its hardness,

(c) a disintegrating agent if it is desired to increase the rate of penetration into the tablet of the liquid phase of matter to be thickened;

(d) a fragrance intended to mask the odors of the matter to be thickened, or else

(e) a coloring agent suitable for conferring the tablet with a particular color, whether this is for the purpose of improving its presentation or to prevent any confusion with other tablets.

The use of a superabsorbent polymer complying with the criteria defined above has proved to yield tablets having a cohesion and a hardness high enough to adequately withstand the impacts that they are likely to undergo, especially during packaging and storing operations following their manufacture.

Thus, according to the invention, the tablet is preferably a bare tablet so as, in this case also, to simplify as much as possible its method of manufacture. However, it is very easy to envisage coating it with a fine continuous or discontinuous film intended to protect it against impact or moisture, or to provide it with a particularly attractive appearance, in which case this film preferably consists of an coating agent capable of dissolving quickly in water.

According to yet another advantageous embodiment of the invention, the tablet is provided with one or more grooves so that it can be divided. This embodiment in fact has the advantage of allowing the patient to adjust the amount of superabsorbent to the size of the collection bags that they use and/or the volume of matter collected in these bags between two emptyings.

According to a preferred embodiment of the invention, the tablet has, when it is placed in an aqueous solution comprising 9 g/l sodium chloride and having a temperature of 24±1° C., an absorption capacity an absorption capacity [sic] at least equal to 25 times, and preferably between 30 and 45 times, the volume that it has in the dry state.

The tablet according to the invention may have various shapes: it may especially have a circular, rectangular or hexagonal cross section, with flat faces or convex faces with identical or different curvatures, or even be spherical or of ovoid shape. Its dimensions can also be very different depending on its intended function; thus, for use in bags for collecting bodily excretions, these dimensions are mainly chosen depending on the size of the opening in the bags through which it is likely to be inserted (bag nozzle or emptying outlet depending on the case) as well as the size of the bags and, consequently, the volume of matter likely to be collected in the latter.

According to the invention, the tablet is advantageously manufactured by direct compression, that is to say by a method which consists in directly compressing the superabsorbent polymer powder, alone or previously mixed with the excipient or excipients, where the tablet is intended to contain one or more excipients, into the form of tablets ready to be packaged. A method such as this is by far the most economical method of manufacturing tablets because of the very small number of operations that it uses and of equipment items that is required.

Given its sensitivity to moisture, the tablet is, preferably, packaged in individual wrappings which are airtight and watertight, such as for example sachets made from aluminum foil lined with a polyethylene film.

The tablet according to the invention has numerous advantages and, in particular, those:

(1) of having an absorption capacity/dry-state volume ratio substantially greater than that presented by the superabsorbent tablets proposed in the prior art,

(2) of consequently being likely, for an absorption capacity at least equivalent to that of the latter, to have smaller dimensions than those of the tablets of the prior art, and thus of being easier to handle and, in particular, to introduce into bags for collecting bodily excretions,

(3) of having, moreover, a cohesion and a hardness high enough to adequately withstand impacts,

(4) of not leading to any increase in volume of liquid matter during the gelling, and

(5) finally of being able to be manufactured by a method which is extremely easy to implement and economically very attractive.

With regard to the above, the tablet according to the invention is particularly well suited for use in the field of collecting bodily excretions.

The subject of the present invention is also, therefore, the use of a tablet as defined above for gelling liquid matter which may be collected in a bag for collecting bodily excretions, and a bag for collecting bodily excretions which comprises such a tablet. Ileostomy bags, urostomy bags and drainage bags are especially likely to be provided with such a tablet, whether for adult bags or pediatric bags.

However, it is well understood that the tablet according to the invention may also find applications in numerous other fields where gelling of liquid matter may be sought, such as in the manufacture of diapers for babies or articles of feminine hygiene.

The invention will be better understood from the additional description which follows and which refers to an exemplary embodiment of tablets according to the invention.

However, it goes without saying that this example is given only by way of illustration of the invention and in no way constitutes any limitation.

### EXAMPLE

### Preparation of Tablets According to the Invention Intended for Ileostomy Bags

Tablets with a circular cross section and flat faces, with a diameter of 32 mm and a thickness of 7.5±0.5 mm and containing only a superabsorbent polymer were prepared by subjecting Norsocryl® 99EX007 to direct compression by means of a Frogerais® press of the alternative number 1 type. The pressure exerted on the dies of the press was 1.5×10⁵ MPa.

The tablets thus prepared each contained 6.5 g superabsorbent polymer and had a hardness greater than 196.2 N.

Their absorption capacity was measured by placing a tablet at the bottom of a beaker and determining the volume of a 9 g/l NaCl aqueous solution with a temperature of 24±1° C. that needed to be added to the beaker in order to completely change the tablet into a gel. Having carried out this test several times, the volume of solution allowing complete transformation of the tablet into a gel proved to be on average 225 ml, which is equivalent to an absorption capacity of about 37 times the volume of said tablet in the dry state (6.0375 ml).

Moreover, tests consisting in placing a tablet in a beaker filled with a predetermined volume (for example 200 ml) of a 9 g/l NaCl aqueous solution with a temperature of 24±1° C. and in comparing this volume before and after gelling showed that it is not altered by the gelling.

Although embodiments, compositions, examples, and uses of the superabsorbent tablet of the invention have been shown and described, it is to be understood that various modifications, additions, and rearrangements of the parts, components or constituents of the composition and its preparation, as well as other examples and uses of the invention can be made by those skilled in the art without departing from the novel spirit and scope of the invention.

What is claimed is:

1. Tablet, characterized in that it comprises a pulverulent superabsorbent polymer having a density less than or equal to 5×10² kg/M³ and a gelling time of less than 6 seconds.

2. Tablet according to claim 1, characterized in that the superabsorbent polymer is a crosslinked sodium or calcium polyacrylate.

3. Tablet according to claim 2, characterized in that the superabsorbent polymer is a crosslinked sodium polyacrylate which exhibits a density of about 4.2×10² kg/m³ and a gelling time of about 4 seconds.

4. Tablet according to any one of the preceding claims, characterized in that it is free from any excipient.

5. Tablet according to any one of the preceding claims, characterized in that it is a bare tablet.

6. Tablet according to any one of the preceding claims, characterized in that it comprises one or more grooves so that it can be divided.

7. Tablet according to any one of the preceding claims, characterized in that it exhibits, when it is placed in an aqueous solution comprising 9 g/l sodium chloride and having a temperature of 24±1° C., an absorption capacity at least equal to 25 times, and preferably between 30 and 45 times, its volume in the dry state.

8. Tablet according to any one of the preceding claims, characterized in that it is manufactured by direct compression.

9. Use of a tablet according to any one of claims 1 to 8 for gelling liquid matter which may be present in a bag for collecting bodily excretions.

10. Bag for collecting bodily excretions, characterized in that it comprises a tablet according to any one of claims 1 to 8.
